(19) United States
(12) Patent Application Publication
(10) Pub. No.: US 2022/0226916 A1
(43) Pub. Date: Jul. 21, 2022

(54) A PORTABLE AUTOMATIC PANEL CUTTER AND A METHOD FOR MARKING PANEL PARTS

(71) Applicant: Kobots ApS, Odense S (DK)

(72) Inventors: Peter Murmann HARTVIGSEN, Svendborg (DK); Kristian DALGAARD, Odense C (DK); Knud ENGBJERG, Odense C (DK)

(73) Assignee: Kobots ApS, Odense S (DK)

(21) Appl. No.: 17/605,612

(22) PCT Filed: May 1, 2020
(86) PCT No.: PCT/DK2020/050124

§ 371 Date: Oct. 22, 2021

(30) Foreign Application Priority Data
May 1, 2019 (DK) PA 2019 70280

(51) Int. Cl. B23D 59/00; B27B 5/07; G06F 3/16

(52) U.S. Cl. CPC B23D 59/003; B23D 59/007; G06F 3/167; B27B 5/07; B23D 59/008

(57) ABSTRACT

Disclosed is a portable automatic panel cutter (1) comprising one or more remote operator interfaces (2) adapted to receive instructions from an operator regarding dimensional processing of a panel (3) in the portable automatic panel cutter (1). The portable automatic panel cutter (1) is adapted to automatically cutting the panel (3) into two or more panel parts (4) according to the instructions. Furthermore, the portable automatic panel cutter (1) also comprises an automated marker tool (5) configured for marking at least one of the two or more panel parts (4) with one or more identification marks (6) in response to the instructions. A method for marking one or more panel parts in a portable automatic panel cutter (1) and use of a portable automatic panel cutter (1) is also disclosed.

### FIELD OF THE INVENTION

The invention relates to a panel cutter for cutting a panel into at least two panel parts and a method for marking the panel parts.

### BACKGROUND OF THE INVENTION

Manual panel cutters are used for cutting panels, profiles, plasterboard, plywood, laminates or other kind of panels. They usually comprise some sort of table with a rotating saw blade which is fixed to the table or fixed on a manually operable sliding carriage. Manual panel cutters are practical because they can be made portable and thereby can be used on building sites, at restauration projects or other places for cutting panels. However, such panel cutter needs to be manned at all times during use.

It is therefore an object of the present invention to provide for a more efficient panel cutter technique.

The Invention

The invention provides for a portable automatic panel cutter comprising one or more remote operator interfaces adapted to receive instructions from an operator regarding dimensional processing of a panel in the portable automatic panel cutter. The portable automatic panel cutter is adapted to automatically cutting the panel into two or more panel parts according to the instructions. The portable automatic panel cutter also comprises an automated marker tool configured for marking at least one of the two or more panel parts with one or more identification marks in response to the instructions.

It is advantageous to form the panel cutter as a portable automatic panel cutter capable of cutting a panel automatically in response to instructions provided from a remote operator interface in that the operator (or operators depending on the number of interfaces) hereby is able to feed the measurement—on the basis of which the panel is to be cut—directly from where the measurements are taken—thereby freeing the operator up to be more efficient. And although remote, the operator is still “programming” the cutter, so that the removal of finished panel parts and the feeding of new panels to the portable automatic panel cutter can be performed by any unskilled worker. However, when the operator or operators are not necessarily present at the portable automatic panel cutter during the cutting process, the finished panel parts may easily get mixed up. It is therefore advantageous to provide the portable automatic panel cutter with an automated marker tool for marking the finished panel parts automatically with identification marks in response to the instructions from the operator(s) so that the operator may more easily identify the panel parts corresponding to specific instructions. Furthermore, such marking enables that any unskilled worker may be used for distributing the cut panel parts to the specific operators or specific job sites and thereby enabling that the operator may be even more efficient.

In this context, the term “marker tool” should be understood as a marking device or a marker capable providing a panel with an identification mark such as any kind of printer, laser printer, inkjet printer, laser marker, pen, wood scorch tool or other or any combination thereof.

In this context, the terms “automatic” and “automated” should be understood as a device or a process which is automated—i.e. not manual—with respects to its movements and/or operation. The term does not exclude that manual operation is involved—e.g. manual feeding of panels to the panel cutter—by the automated process itself is performed automatically without manual labour.

In this context the term “panel cutter” should be understood as a machine for cutting panels such as plates, boards, sheets or the like into predetermined dimensions and/or pieces.

It should be noted that in this context the term “instructions” should be understood as providing basic measurements, selecting a cutting template, providing operator identification, providing job identification, providing material selection, providing tool selection or other or any combination thereof.

In this context, the term “remote operator interface” should be understood as a device capable of receiving instructions from an operator at a distance from the portable automatic panel cutter—hence “remote”—and provide the instructions to the portable automatic panel cutter so that it may automatically cut a panel in the portable automatic panel cutter on the basis of these instructions. Thus, the term “remote operator interface” would include any kind of smartphone, handheld control device, tablet, handheld input device or other type of device for allowing an operator to provide instructions to the portable automatic panel cutter from a distance e.g. wirelessly or through a long cable. Thus, in this context the “remote operator interface” is portable independently from the portable automatic panel cutter.

In an aspect of the invention, the one or more remote operator interfaces comprise wireless communication means arranged to communicate wirelessly with the portable automatic panel cutter.

It is advantageous to provide the remote operator interfaces with wireless communication means for communicating wirelessly with the portable automatic panel cutter in that an operator may become more mobile.

In an aspect of the invention, the automated marker tool is arranged to operate contact-free in relation to the panel parts.

This is advantageous in that the identification mark may be provided to the panel parts in a distance from the panel parts which is advantageous in that the automated marker tool does not contact with dust, flakes and other impurities which may be present on the surface of the panel and which may contaminate and eventually block the output of identification marks from the automated marker tool. Furthermore, the identification marking may be provided to the panel parts while they are in motion and without having to stop the panel parts first whereby the process of cutting and marking panels is faster and more efficient.

In an aspect of the invention, the automated marker tool comprises an inkjet printer.

This is advantageous in that an identification mark may be provided by utilizing a ready-to-use device that is simple and inexpensive. Furthermore, an inkjet printer typically comprises means for moving the printer-point at least in one direction thus enabling that symbols, text or other may be printed by only moving the inkjet printer in one direction across the surface of the panel or even when holding the inkjet printer stationary in front of the panel surface—i.e. at least some of the automation may be provided by the marker tool itself. Thus, the panel may be provided with relative complex identification marks faster by using an inkjet printer as marker tool.

In an aspect of the invention, the automated marker tool comprises a pen.

A pen is a very inexpensive marking tool that may easily be replaced. Thus the marker tool may easily be adapted to the specific task simply by replacing the pen.

In an aspect of the invention, the marker tool comprises a label maker.

This is advantageous in that a label maker may print the identification marks in a more controlled environment inside the label maker and then apply the label after it has been printed. Furthermore, the label may be printed while the panel is being cut thus enabling that complex markings can be provided without it taking extra time.

In an aspect of the invention, the portable automatic panel cutter comprises a power cutter releasably suspended in a power cutter holder.

It is advantageous if the portable automatic panel cutter comprises a power cutter releasable suspended in a power cutter holder in that the power cutter can easily be disconnected making the panel saw lighter and thereby easier to move around between job sites. Furthermore, off-the-shelf power tools may be used in the portable automated panel cutter which means that the panel cutter no longer is categorised as “Dangerous machinery” and the authorisation procedure for such a portable automated panel cutter is much simpler and inexpensive. Standard power cutters are already safety approved whereby no further clearances or documentation is necessary which shortens the time-to-market period for the portable automated panel cutter. Furthermore, independent power cutters are readily available at a building site or in hardware stores and the power cutter can therefore easily be replaced in dependency of the specific job or in case of repair or breakdown.

In an aspect of the invention, the portable automatic panel cutter is arranged to move the power cutter holder in a three-dimensional cartesian coordinate system and to rotate the power cutter holder around a holder rotation axis parallel to an axis of the three-dimensional cartesian coordinate system.

A cutting blade can only cut efficiently in one direction and it is therefore advantageous that the portable automatic panel cutter is arranged to rotate the power cutter holder around a holder rotation axis and to move the power cutter holder in a three-dimensional cartesian coordinate system to enable that the power cutter may cut through the panel in different directions and that more complex cuts may be performed by the portable automated panel cutter.

In an aspect of the invention, the portable automatic panel cutter further comprises a support area arranged to support a panel during cutting of the panel.

It is advantageous to provide the portable automatic panel cutter with a support area for supporting a panel during cutting in that the cutting process may be performed more precise and stable.

In an aspect of the invention, the three-dimensional cartesian coordinate system comprises a X-direction and a Y-direction both being substantially parallel with the support area and a Z-direction being substantially perpendicular to the support area.

It is advantageous to provide an X-direction and a Y-direction of the cartesian coordinate system parallel with the support area and a Z-direction substantially perpendicular to it in that the XY plane is thereby substantially parallel with the support area whereby it is easier to determine at which point in space the cutting tool is cutting the panel. More specifically, the cut out of e.g. a rectangular panel could be performed at a constant Z-value and therefore triangulation is not necessary to calculate the position of the cutting tool in relation to the panel as would be necessary if the XY-plane was for example tilted in relation to the support area. Furthermore, it is not necessary to adjust the Z-position while cutting since this is, as mentioned, performed at a constant Z-value.

In an aspect of the invention, the portable automatic panel cutter comprises a controller for controlling the motion of the power cutter holder in a three-dimensional cartesian coordinate system and to control rotation of the power cutter holder around a holder rotation axis parallel to an axis of the three-dimensional cartesian coordinate system.

It is advantageous to provide the portable automatic panel cutter with a controller which controls the motion and rotation of the power cutter holder in that the operator is able to perform other tasks while the controller controls the portable automatic panel cutter to manufacture e.g. a panel with a specific dimension or shape.

Furthermore, it is advantageous if the holder rotation axis is parallel to an axis of the three-dimensional cartesian coordinate system in that the cutting plane of the power cutter corresponds to the plane formed by the remaining two axes of the cartesian coordinate system. Thereby, the cutting path may be represented by a set of coordinates in 2D which makes it easier to control the cutting point.

In an aspect of the invention, the controller comprises means for controlling movement of the power cutter holder in the X-direction and the Y-direction simultaneously.

It is advantageous if the controller comprises means for operating the displacement means in both the X- and Y-direction simultaneously in that more complex cutting patterns may be performed, e.g. a diagonal cutting of a rectangular panel.

In an aspect of the invention, the portable automatic panel cutter comprises X-direction drive means for driving the power cutter holder in a X-direction of the three-dimensional cartesian coordinate system, Y-direction drive means for driving the power cutter holder in a Y-direction of the three-dimensional cartesian coordinate system, Z-direction drive means for driving the power cutter holder in a Z-direction of the three-dimensional cartesian coordinate system and rotation means for rotating the power cutter holder around the holder rotation axis.

It is advantageous to provide drive means for X-, Y- and Z-direction movement of the power cutter holder and rotation means for rotating the power cutter holder around the holder rotation axis in that each movement is decoupled from the other whereby a variety of cutting patterns may be performed.

In an aspect of the invention, the X-direction drive means, the Y-direction drive means, the Z-direction drive means and/or the rotation means comprises an electric motor.

It is advantageous if the X-, Y-, Z-direction and/or the rotation means each comprises an electric motor in that an automated control of the respective movements may be more easily achieved.

In an aspect of the invention, the holder rotation axis is parallel with the Z-direction.

It is advantageous if the holder rotation axis is parallel with the Z-direction in that the power cutter may be rotated around the Z-direction such that for example a curved cutting path may be obtained. Furthermore, providing the holder rotation axis parallel with the Z-direction means that the cutting plane is parallel to the XY-plane. Thus, the cutting path may be determined from X- and Y-coordinates which makes the it easier to control the point of cutting.

In an aspect of the invention, the power cutter is a stand-alone power cutter designed to be operated by hand.

It is advantageous to use a stand-alone power cutter in that it is an already developed fit-for-purpose tool comprising its own safety features, approvals and other. Furthermore, it is advantageous in that the user may easily switch between different power cutters depending on the task or replace the power cutter in case of repair or breakdown.

In an aspect of the invention, the automated marker tool is mounted on the power cutter holder.

This is advantageous in that no separate support must be designed to support the marker tool itself. Furthermore, mounting the marker tool on the holder is advantageous in that the marker tool follows the power cutter holder to the panel parts to be cut and marked whereby no separate displacement means for moving the marker tool must be designed.

In an aspect of the invention, the portable automatic panel cutter is arranged to cut the panel in a cutting point and wherein the automated marker tool is offset from the cutting point.

The space around the cutting point is tight and present a very harsh environment. Thus, it is advantageous to offset the automated marker tool to make it easier to fit the marker tool and to protect it better. However, it should be understood that just because the automated marker tool is offset in relation to the cutting point does not exclude that the automated marker tool is able to make the panel parts in the cutting point—e.g. by being angled or other.

In an aspect of the invention, automated marker tool (5) is arranged to be automatically moved at least partly by the X-direction drive means, the Y-direction drive means (14), the Z-direction drive means (15) and/or the rotation means adapted to displace a power cutter performing said cutting during said automatically cutting of the panel.

It is advantageous if the marker tool is automatically moved, at least partly, by the displacement means adapted for moving the power cutter in that the marker tool may be moved to a specific panel to be cut and marked by using the same displacement means without designing separate displacement means for the marker tool.

In an aspect of the invention, the automated marker tool is provided with marker displacement means arranged independent to the X-direction drive means (13), the Y-direction drive means (14), the Z-direction drive means (15) and/or the rotation means (16) adapted to displace a power cutter performing said cutting during said automatically cutting of said panel.

This is advantageous in that the marker tool may be moved around independently from the power cutter performing the cutting such that the identification mark may be provided in a position where the power cutter has not necessary passed during cutting of the panel.

In this context, the term “marker displacement means” should be understood any kind of maker displacer capable of displacing the automated marker tool—such as any kind of rack and pinion mechanism, gear mechanism, pulley system, actuators, belt drive/system, electro motors or other or any combination thereof.

In an aspect of the invention, the automated marker tool comprises means for displacing the automated marker tool independently in at least one direction in relation to the X-direction drive means (13), the Y-direction drive means (14), the Z-direction drive means (15) and/or the rotation means (16) adapted to displace a power cutter performing the cutting during the automatically cutting of the panel.

This is advantageous in that the automated marker tool may be displaced such that it is offset in at least one direction in relation to a cutting point of the power cutter such that the identification mark is not interfering with the cutting point and such that the marking tool may be in a more protected position during the cutting process and then be moved out during marking.

In an aspect of the invention, the remote operator interface is configured to receive the instructions from the operator by means of voice commands.

This is advantageous in that the operator may provide instructions to the automated portable panel cutter without discontinuing working with his hands or that his attention may be kept on other construction tasks instead of operating the remote operator interfaces.

In an aspect of the invention, the portable automatic panel cutter comprises two or more remote operator interfaces.

This is advantageous in that at least two operators may use the portable automatic panel cutter. Each operator could be positioned at different positions at a construction site and provide the instructions independently from each other. Furthermore, more than one remote operator interfaces will enable a more efficient use of the capacity of the portable automatic panel cutter in that job orders from different operators/interfaces can be queued and initiated as soon as the portable automatic panel cutter is ready for a new task.

In an aspect of the invention, the one or more identification marks comprises a barcode or a QR code.

Using barcodes or QR codes as identification mark is advantageous in that these codes are very standardised, they are easy to form, and in that barcodes and QR codes may store large amount of information in a simple form. Furthermore, it is advantageous if the identification marks comprise a barcode or a QR code in that the identification marks may afterwards be scanned and processed by computer systems. This is advantageous in that a computer may monitor and manage the stock of panels such that material waste may be minimized because the computer may instruct to draw up a panel part with a specific dimension corresponding to the instructions.

In an aspect of the invention, the one or more identification marks comprises information based on the instructions.

This is advantageous in that the operator may easily identify which panel part corresponds to his instructions. This information could be information pertaining to the operator (name, identification number, role etc), the panel dimensions, position, assembly number or other type of information based on the instructions.

In an aspect of the invention, the one or more identification marks comprises information that are unique for an operator or a remote operator interface.

This is advantageous in that a plurality of operators may operate the portable automatic panel cutter without intermixing the cut panel parts in that these are provided with information which couples each panel part to an operator or a remote operator interface. Such information could be name, identification number, role, remote interface number or other kind of information for uniquely coupling the identification mark to an operator or a remote operator interface

In an aspect of the invention, the portable automatic panel cutter comprises a power socket. Power to the power socket is controlled by a controller arranged to control the automatically cutting of the panel.

It is advantageous if the portable automatic panel cutter comprises a power socket in that the power cutter may be provided with power by plugging it directly to the power socket of the panel cutter, thus enabling that a completely standard off-the-shelf power tool may be powered by the panel cutter without modifications and when the power cutter is not mounted in the panel cutter it may thus be used as a normal power tool. Also, it is advantageous if the power to the power socket is controlled by a controller in that e.g. power could be supplied only when the panel cutter must operate whereby the panel cutter is more efficient.

In an aspect of the invention, the independent power cutter is provided with a power plug through which power is supplied to the power cutter.

It is advantageous if the independent power cutter is provided with a power plug through which power is supplied to it in that it enables that the supply of power to the power cutter can be controlled externally—e.g. by controlling the power to the socket to which the plug is connected—hereby enabling that a standard power tool may be used in an automated panel cutter. Furthermore, this enables that more standard off-the-shelf power cutter may be used.

In an aspect of the invention, the portable automatic panel cutter comprises a number of feet arranged to support the portable automated panel cutter against the underlying ground during normal use of the portable automated panel cutter, wherein a contact surface of the feet forms a contact plane, wherein the portable automated panel cutter further comprises a support area arranged to support a panel during cutting of the panel and wherein the support area in arranged in an angle between 20 and 90, preferably between 45 and 86, and most preferred between 65 and 82 degrees in relation to the contact plane.

If the support area is closer to being vertical (during normal use of the automated panel saw) the panel may tip over and fall out of the support area and if the support area is closer to being horizontal (during normal use of the automated panel saw), the panel cutter takes more space and the panels may be harder to access and lift away because the operator must seize the panels in an awkward position. Thus, the above-mentioned ranges present an advantageous relationship between space consumption and being user-friendly.

Also, it is advantageous to provide the portable automated panel cutter with a number of feet in that the weight of the panel cutter is more well-distributed and more stable.

In an aspect of the invention, the portable automatic panel cutter is releasably assembled by several individual panel cutter parts, and wherein each of the individual panel cutter parts can be carried by hand.

It is advantageous if the portable automated panel cutter is releasably assembled by several panel cutter components in that it may be dis-assembled and re-assembled at different sites or positions which provides for more flexibility. Furthermore, it is advantageous if the individual components may be carried by hand in that no machinery (which there may not be available space for) is necessary in order to move the components to a different place for erecting the portable automated panel cutter there.

It should be emphasized that “carried by hand” is to be understood such that the individual parts have a weight which allow an operator to repeatably lift, move and lower the components without being subjected to too much exhaust or physical fatigue. I.e. each of panel cutter parts does not weigh more than 50 kg, preferably not more than 40 kg, and most preferred not more than 30 kg.

In an aspect of the invention, the power cutter comprises a power button and wherein the power button is locked in an on state.

Since the standard power cutter comprises a power button and means to lock it in an on state anyway it is advantageous to lock it in on state in that the operating state of the power cutter may be controlled by control of the power supply itself whereby no complex actuating or start up mechanism for operating the power button is necessary.

In an aspect of the invention, the power cutter comprises rotating drive shaft for rotating a circular cutting blade.

It is advantageous to provide the power cutter with a rotating drive shaft in that the circulating cutting blade cuts the workpiece by cutting chips or flakes which are then directed away from the cutting blade (and cutting area) due to the tangential velocity whereby the power cutter does not get stuck due to accumulated dust, chips and flakes.

In an aspect of the invention, the circular cutting blade is a saw blade.

It is advantageous if the circular cutting blade is a saw blade in that such a circular saw blade is suitable for sawing panels made of hard materials such as wood, metal, stone, ceramic or other.

In an aspect of the invention, the marker tool comprises a laser marker.

Using a laser as marker tool is advantageous in that a laser is versatile and can write on just about any surface and in that it can write touch-free. Furthermore, by use of fibre optic cables the laser itself can be located elsewhere on the portable automatic panel cutter thus free up space at the power cutter holder.

In an aspect of the invention, the portable automatic panel cutter comprises a button actuator arranged to mechanically engage a power button on the power cutter.

Actively engaging the power button of the power cutter with a button actuator is advantageous in that the power cutter is then only activated when it is needed. Furthermore, such a button actuator can relatively easily be provided with a return mechanism ensuring that the button actuator will automatically retract in case of a power outage. This is advantageous in that locking the power button in an always-on state can be problematic in relation to certain rules or laws.

The invention also provides for a method for marking one or more panel parts in a portable automatic panel cutter. The method comprising the steps of:
providing instructions to a remote operator interface regarding dimensional processing of a panel in the portable automatic panel cutter,
transmitting the instructions from the remote operator interfaces to a controller of the portable automatic panel cutter,
automatically cutting the panel into two or more panel parts in the portable automatic panel cutter in response to the instructions, and
marking at least one of the two or more panel parts with one or more identification marks in response to the instructions.

It is advantageous to provide for a method for marking one or more panel parts in a portable automatic panel cutter according to the above-mentioned method in that it is easier for the operator to identify which panel part corresponds to the instructions provided to the potable automatic panel cutter. Furthermore, the above-mentioned method provides the operator with the possibility of performing other tasks while the panel cutter automatically cuts the panel into two or more parts and marks them so that the operator may easier identify which panel part corresponds to the instructions given.

In an aspect of the invention, the method comprises the step of releasably connecting an independent power cutter to a power cutter holder of the portable automatic panel cutter before the power cutter is automatically cutting the panel.

This is advantageous in that the operator may use power cutters which are usually already present at the construction site, factory, workshop or other similar places for automatically cutting the panel. Also, this enables that the operator may switch between different types of power cutters depending on the cutting task.

In an aspect of the invention, the method comprises the step of placing a panel in the portable automatic panel cutter.

This is advantageous in that the method of marking one or more panel parts in a portable automatic panel cutter may be performed repeatedly by continuously feeding the portable automatic panel cutter with panels.

In an aspect of the invention, the method comprises the step of automatically cutting the panel into two or more panel parts by means of the controller automatically displacing a power cutter, wherein the power cutter is releasably connected to a power cutter holder arranged to be moved automatically in a three-dimensional cartesian coordinate system and to be automatically rotated around a holder rotation axis parallel to an axis of the three-dimensional cartesian coordinate system.

It is advantageous if a controller automatically displaces an independent power cutter in that the operator does not have to repeatedly switch the cutting direction whereby the operator may perform other tasks while the controller controls the cutting.

In an aspect of the invention, the method comprises the step of plugging a power plug of a power cutter into a power socket of the portable automatic panel cutter before the power cutter automatically cuts the panel, wherein the power socket provides power to drive the power cutter and wherein power to the power socket is controlled by the controller of the portable automatic panel cutter.

This is advantageous in that a ready-for-use power tool may be mounted on the automatic panel cutter and plugged into the power source of the panel cutter whereby no modifications of the power tool electrical system are needed.

Furthermore, this is advantageous in that the panel cutter is always provided with sufficient amount of power and that the power cutter may be controlled through control of the power to the power socket.

In an aspect of the invention, the method comprises the step of locking a power button of the power cutter in an on state.

This is advantageous in that the operation of the power cutter at all times can be controlled simply by controlling the power supply to the power cutter, thus avoiding having to modify the power cutter.

In an aspect of the invention, the method comprises the step of releasably assembling several individual panel cutter parts on-site to form the portable automatic panel cutter.

This is advantageous in that the operator may disassemble the panel cutter, move to a different position (e.g. construction site, factory, mill or other position) and re-assemble the panel cutter which provides for more flexibility.

In an aspect of the invention, each of the individual panel cutter parts are carried on-site by hand.

It is advantageous if the individual panel cutter parts are carried on-site by hand in that the panel cutter is portable by hand whereby no expensive machinery is needed to move it around to different positions.

In an aspect of the invention, the method for marking one or more panel parts in a portable automatic panel cutter is performed on a portable automatic panel cutter according to any of the previously described portable automatic panel cutters.

Using the previously described portable automatic panel cutters for carrying out the previously described method is advantageous in that it provides for a more efficient cutting process.

The invention further provides for use of a portable automated panel cutter according to any of the previously described portable automatic panel cutters used for cutting panels on a building, repair or restauration site.

It is particularly advantageous to use a portable automated panel cutter according to the present invention at a building, repair or restauration site because only small batches of the same type of panels are cut at each site making a standard CNC panel cutter too uneconomic an impractical and making a manual panel cutter too labour demanding and inflexible.

According to an exemplary embodiment of the invention, the portable automated panel cutter is collapsible. This is advantageous in that it has the effect, that the portable automated panel cutter is collapsible and thereby be folded into a small space and unfolded at the construction site without significant mounting effort from the user.

According to an exemplary embodiment of the invention, the portable automated panel cutter is at least partly collapsible. This is advantageous in that it has the effect, that the portable automated panel cutter is at least partly collapsible and thereby be at least partly folded into a small space and unfolded at least partly at the construction site without significant mounting effort from the user.

According to an exemplary embodiment of the invention, a cutter tool of the power cutter is a sawblade.

### FIGURES

The invention will be described in the following with reference to the figures in which

FIG. 1. illustrates the portable automatic panel cutter as seen in perspective,

FIG. 2 illustrates an embodiment of the power cutter as seen in perspective, and

FIG. 3 illustrates a cross section through a power cutter holder as seen from the bottom

FIG. 4 illustrates a cross section through a power cutter holder and adaptor, as seen from above.

### DETAILED DESCRIPTION

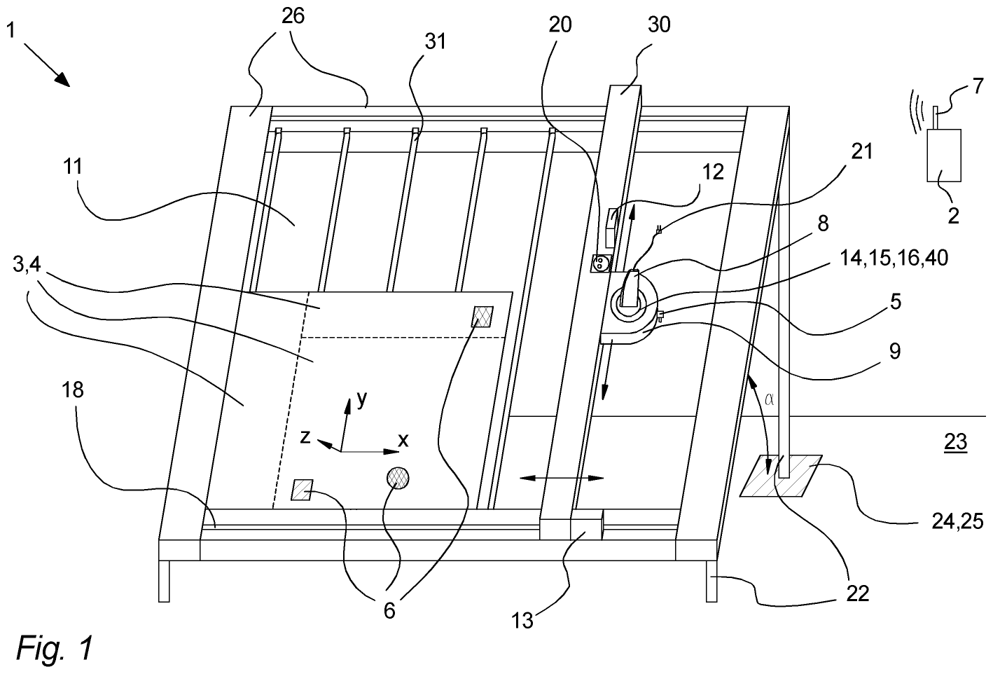

FIG. 1 illustrates the portable automatic panel cutter 1 as seen in perspective

The portable automated panel cutter 1 comprises a plurality of panel cutter parts 26 and each individual part 26 may be carried by hand. Thus, in this embodiment the operator may take the panel cutter 1 apart by unscrewing some screws or bolts, by disengaging interlocking parts, by releasing snap locks or the like and move the cutter parts 26 to any location in which the cutting work must be performed. This could for example be done by carrying the cutter parts 26 in in dedicated holder, by means of handles, in a bag or other. The cutter parts 26 are then assembled to form the panel cutter 1. Then, when a panel 3 is to be cut, it may be positioned in a support area 11 of the portable automated panel cutter 1 which is formed when the panel cutter parts 26 are assembled. Depending on the type of material of the panel 3 and the type of cutting to be performed, a specific power cutter 8 may be chosen. For example, if straight cuts are to be performed, e.g. if the panel 3 must be cut in just two pieces in a straight line, a circular saw may be used for such a purpose. The power cutter 8 is then connected to the power cutter holder 2 which is connected to the traverse beam 30. When the traverse beam 30 moves in the x-direction, the power cutter holder 2 and the power cutter 8 follow the same motion as these are connected to the traverse beam 30—in this case releasably connected to the traverse beam 30. The power cutter holder 9 further comprises Y-direction drive means and Z-direction drive means for moving the power cutter holder in Y- and Z-direction, respectively.

In this embodiment the power cutter holder 2 is a more complex structure surrounding the power cutter 8 but in another embodiment the power cutter holder 2 could be formed more as a plate, an arm, a bracket or other type of structure for supporting a power cutter 8 connected to the traverse beam 30.

The movements in the respective cartesian coordinate axis (x, y and z) and the rotation around the holder rotation axis 4 may be achieved in numerous ways. In this embodiment, the x-direction movement is achieved by an electric motor which moves the traverse beam 30 by e.g. a set of wheels (not shown) engaging a track 18. However, in another embodiment, the displacement means (13,14,15,16) could be a magnetic system, belt drive, pulley system, a spindle drive, a rack and pinion or other kind of mechanism for moving the traverse beam 30 in the x-direction. And in an embodiment, instead of using an electric motor for moving the traverse beam 30, a hydraulic actuator, pneumatic actuator, engine or other type of drive means could be used for the purpose of moving in the x-direction. This also applies to the y- and z-direction movements and the rotation means 16 for rotation around the holder rotation axis 10 i.e. in this embodiment the automated displacement means comprises four electrical motors each driving one of the x, y and z direction and performing the rotation of the power cutter holder 9.

In this embodiment the rotation drive means 16 comprises a bearing (not shown) and an endless belt (not shown) encircling an inner opening of the power cutter holder 9 so that an inner part of the power cutter holder 2 is rotated, and thereby the power cutter 8, when the belt is pulled by means of an electrical motor and a pulley.

When a panel is to be cut, the operator may instruct the portable automatic panel cutter 1 to cut a panel 3 into a specific size, dimension, particular shape via a remote operator interface 2. In this embodiment, the operator may provide instructions to the remote operator interface 2 via a keyboard, but in another embodiment the operator could provide the instructions orally (i.e. by voice commands), through a touchscreen, by providing a picture of a targeted panel shape or in other suitable ways. The instructions may then preferably be transmitted from the remote operator interface 2 to the panel cutter 1 via wireless communication (Wi-Fi, mobile telecommunication network or via other long range wireless communication protocols such as SigFox, LoRa or other), such that the operator may freely move around at e.g. a construction site without being constrained by the limited length of a cable. Furthermore, a plurality of operators may do exactly the same, e.g. a craftsman at another position on a construction site needing a panel 3 of a specific size could provide instructions to the panel cutter 1 via his own remote operator interface 2.

In this embodiment, the remote operator interface 2 comprises wireless communication means 7 for transmitting the instructions wirelessly from the remote operator interface 2 to the panel cutter 1. However, in another embodiment, the operator interface 2 could be wired to the panel cutter 1. In another embodiment the panel cutter 1 could also further be provided with a stationary operator interface (not shown) mounted directly on a suitable position on the panel cutter 1.

In an embodiment where the operator may provide the instructions orally, he may be provided with a headset communicating with the remote operator interface 2 which again communicates with the panel cutter 1. Thus, the operator may provide the instructions without using his hands and thereby simultaneously perform other tasks such as assembling already cut panel parts 4 or acquiring dimensions to provide new instructions. There is also a safety aspect in that the operator does not have to focus his attention to e.g. a monitor and keyboard of the remote operator interface 2 for feeding the instructions to the interface 2. One has to keep in mind that the operator may be at a construction site with potentially dangerous machinery or he may be working from a scaffold where it may be vital that his hands are free. Also, workmen are often using gloves (for example when working in cold weather or when performing a specific task which requires safety gloves) and it is therefore advantageous that the operator does not have to take off the gloves for operating e.g. buttons, a touch screen or other type of action which require full finger control. Even further, the hands may be dusty, greasy or dirty and it is therefore advantageous that the operator interface is configured to receive voice commands in that the remote operator interface 2 is cleaner.

An operator at one position at a construction site could provide the panel cutter 1 with instructions regarding a specific panel part 4 that he needs independently from an operator at a different position. Thus, the portable automated panel cutter 1 may comprise means (small processors, controllers, computer system or other) for handling the multiple instructions such that these are queued and may be prioritized in relation to for example urgency, complexity, operator, number of panels to be cut or other kind of parameter. The computer system may also queue the instructions and put them on hold when the panel cutter 1 lacks panels 3 to be cut and run the instructions as soon as possible, either when a preceding task is performed or when the panel cutter is again fed with panels. The portable automated panel cutter may have a dedicated person for continuously feeding the panel cutter with panels such that the panel cutter may operate non-stop (depending on the work load) or the panel cutter 1 may be provided with automated feeding systems which synchronize the panel feeding with the instruction(s) whereby the panel cutter is more efficient.

When the portable automatic panel cutter 1 has cut a panel 3 into two or more panel parts 4 according to the instructions the automated marker tool 5 provides an identification mark 6 on at least one of the two or more panel parts 4. For example, if the instructions set out that a panel 3 is to be cut almost exactly through the middle, the operator may find it hard to determine which panel part 4 corresponds to his instructions (he may not have been near the panel cutter 1 during the cutting and thereby not have observed the cutting process). Therefore, the automated marker tool 5 is configured to mark the panel 4 which corresponds to the instructions given by the operator. In this example the automated marker 5 would mark the panel part 4 such that the operator may distinguish between the panel parts 4.

In more busy construction sites, the panel cutter 1 may be provided with numerous instructions all the time and from different remote operator interfaces 2 each being used by different operators at different positions. Thus, when one of the operators wants to collect a panel part 4 which corresponds to his instructions, a pile of panel parts 4 may have built up due to the plurality of given instructions. Therefore, the automated marker tool 5 is adapted to provide each of the panel parts 4 with a unique mark corresponding to for example the specific operator or to remote operator interface 2 from which the instructions originate from such that he may quickly identify which panel part 4 corresponds to his instructions.

In another embodiment the automated marker tool 5 may also be used for automated marking of the cut-off or waste plate material so that these parts may more easily be identified as waste or to identify the waste plate material so that the controller 12 of the panel cutter 1 may keep track of the waste plate material and if a specific job can be cut from a specific waste plater part, this specific waste plate part may more easily be identified and reused.

In this embodiment, the automated marker tool 5 is an inkjet printer. In another embodiment, the automated marker tool could be a laser marker, laser printer, a label maker, wood scorch tool, a pen or other. The identification mark 6 itself could be a simple, coloured droplet. For example, each operator may be assigned a specific colour such that the operator may identify the panel parts 4 by looking for a panel part 4 with a specifically coloured droplet. In other embodiments, the identification mark 6 could also be a logo, a specific sign, a short string of text, a letter, a number, an indentation with a specific shape, a label or any other kind of mark which may be provided to the panel part 4 and such that the operator may identify the panel part 4 corresponding to his instructions.

In this embodiment, the identification mark 4 is designed such that the operator may relatively easy and visually identify the identification mark and thereby the panel part 4 corresponding to his instructions. However, in some situations this type of identification mark 4 may not be sufficiently complex (i.e. the amount of information). For example, a complex structure may require many different panel parts 4 and it may quickly become too complex to store a lot of information in simple identification marks. Thus, the automated marker tool 5 may also provide the panel parts 4 with more complex identification marks 4 such as barcodes, QR codes, number series or other machine-readable representation of data capable of storing a lot of information regarding e.g. operator, date, assembly number, GPS position, material or other type of information. The operator may then process such an identification mark via e.g. the remote operator interface 2, which could be provided with a camera, QR scanner, picture scanner or other kind of reading devices for reading and processing the identification mark 6. The reading device could also be arranged separate from the remote operator interface 2.

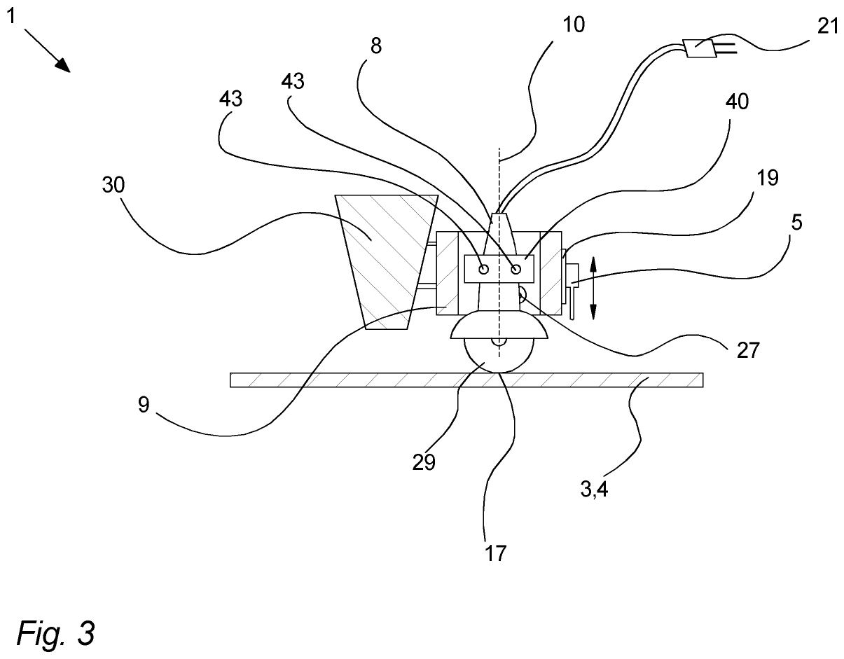

In this embodiment, the automated marker tool 5 is mounted on the outer side of the power cutter holder 9 via screws (not shown) such that it follows the same motion as the power cutter holder 9. In another embodiment, the automated marker tool 5 could be mounted on the inner side of the power cutter holder 9. The automated marker tool 5 could be mounted on the power cutter holder 9 via bolts, screws, by inserting the marker tool in a sleeve (not shown) designed for receiving the marker tool or in any other way. Such a sleeve could be glued, welded, screwed, bolted or by any other means connected to the power cutter holder 9. In another embodiment, the automated marker tool 5 may be provided with marker displacement means 19 (see FIG. 3) arranged to move the automated marker tool 5 in e.g. the z-direction such that it may accommodate to the thickness of a panel 3 e.g. to ensure a certain distance between the printing head and the surface of the panel 3 for printing an identification mark 6 with a desired resolution, quality, size or to avoid collision with the panel 3. The marker displacement means 19 may be arranged to rotate the automated marker tool 5 around a rotation point (not shown) such that the automated marker tool 5 could be angled in relation to the holder rotation axis 10. In some embodiments, the automated marker tool 5 is offset to the cutting point 17 and if the power cutter holder is very close to an edge of the panel 3, the marker tool 5 may protrude outside of the extension of the panel 3 whereby the identification mark 6 may not be provided on the panel part 4. Therefore, it is advantageous if the automated marker tool 5 can be rotated around a rotation point in that the automated marker tool 5 may provide the entire identification mark 6 on the panel part 4 instead of partly or completely missing it.

In another embodiment, the automated marker tool 5 could be located differently on the panel cutter 1—such as on the traverse beam 30 or even on its own dedicated system of displacement means.

In this embodiment the panel cutter 1 is only provided with one automated marker tool 5 but in another embodiment the panel cutter 1 could comprise two or more automated marker tool 5—e.g. dedicated for different jobs, different material, different interfaces or other.

In this embodiment the rotation means 16 are enclosed within the power cutter holder 10 but could also be outside or over the holder 9. In another embodiment the rotation could be achieved by a gear, pulley system, drive shaft or in any other suitable way for connecting the rotation means 16 to the power cutter holder 9 and rotate it around the holder rotation axis 10.

In this embodiment, the holder rotation axis 10 (see FIG. 3) is an axis parallel with the z-axis. However, in another embodiment, the holder rotation axis 10 could be an axis be parallel with the x- or y-axis of the cartesian coordinate system.

The power cutter 8 is connected to the power cutter holder such that the circular cutting blade 29 of the power cutter 8 points towards the support area 11 for cutting a panel 3. The power cutter is connected to the power cutter holder 9 such that the holder 9 and the power cutter 8 may displace in a z-direction e.g. for accommodating the thickness of the panel 3 or for moving the power cutter holder 9 in the cartesian coordinate system without colliding with the panel 3. The power cutter 8 may also be arranged such that it may move in the z-direction independently from the power tool holder 9 such that calibration of the cutting point 17 in the z-direction is possible. In another embodiment alignment of the z-direction is not possible in that a small difference in cutting depth only will result in the cutter tool extending a little further into the support area 11.

The power cutter 8 may be battery-driven or may need to extract power from a power socket. Therefore, in this embodiment, the power cutter 8 comprises a power socket 20 such that a power plug 21 of the power cutter 8 may be plugged directly to the power socket 20 of the panel cutter such that the operator does not have to extend the power plug 21 to a power socket in the factory, construction site, workshop or where ever it may be positioned for use. However, the power socket 20 could naturally also be provided in a nearby power source, for example in a power socket of a factory in which the panel cutter 1 is to be used.

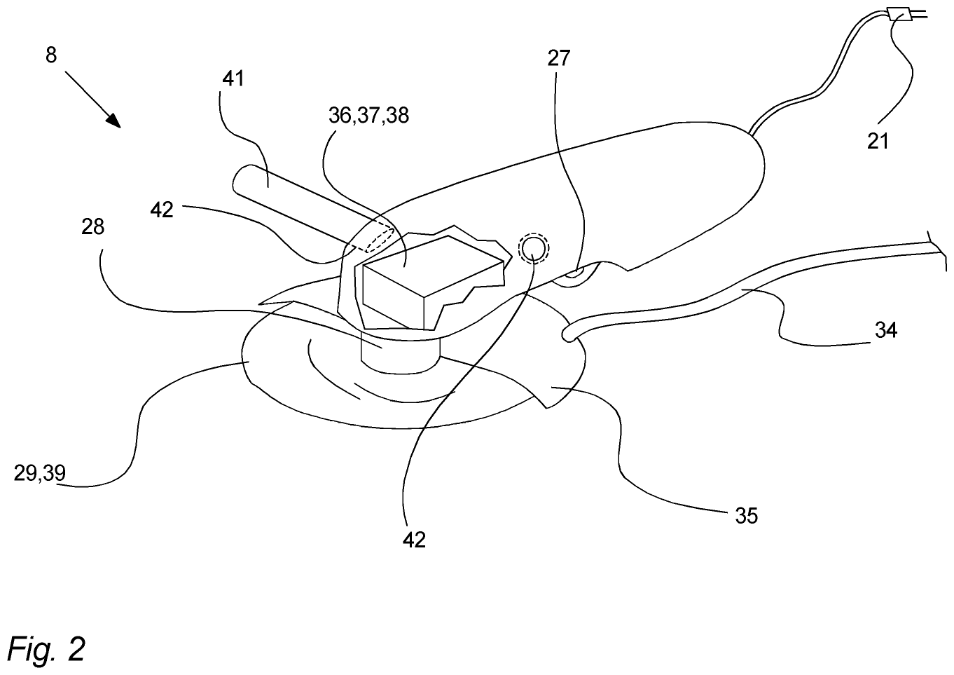

In this embodiment the power button 27 of the power cutter is in an “on” state and the panel cutter 1 comprises a controller 12 arranged to control the x-, y-, z-movement and the rotation around the holder rotation axis 10 and also the power to the power socket 20 such that the controller 12 may control the entire system, i.e. movement in the cartesian coordinate system and the cutting. For example, it may move the holder 9 to a particular (x, y) coordinate, apply power to the power socket 20 such that the power cutter 8 starts cutting and move the power cutter towards the panel in the z-direction to cut the panel 3. In this embodiment, the power cutter comprises a power button 27 (see FIGS. 2 and 3) which is always in the “on” state such that the power cutter 8 is controlled by the controller 12 controlling the power to the power socket 20. However, in another embodiment, the power cutter 8 may not necessarily always be in the “on” state. A power button actuating mechanism (not shown) could be designed such that the controller 12 controls this part instead of (or in addition to) controlling the power to the power socket 20. Such a mechanism for actuating the power button 27 (see FIGS. 2 and 3) could be a simple relay switch, actuator, a spring-actuated arm, mechanism driven by compressed air, a solenoid or other kind of mechanism for actuating the power button 38 via the controller 12.

In this embodiment the controller 12 is placed on the traverse beam 30 but in another embodiment the controller 12 could be placed elsewhere on the panel cutter or it could be located in a separate stand, cupboard or the like.

The controller 12 may control the movement and power supply in response to instructions provided by an operator provided to the panel cutter 1 via a remote operator interface 2 on e.g. a wireless communication means 7. The instructions could be provided to the handheld device via voice commands, a user interface or even by taking a picture of e.g. a targeted shape, which the controller 12 could convert to a cutting path. The instructions could also be provided directly to the controller 12 via a user interface in the panel cutter 1. In order to provide for complex shaped panels 3, the controller 12 could be provided with means for operating the displacement means 3 e.g. in the x- and y-direction simultaneously to make e.g. diagonal cuts or even cutting along a curve. The controller 12 could do this by controlling actuators, belt drives, pulley systems, rack and pinion mechanism or other means displacing in the x- and y-direction simultaneously. The controller 12 may also be used for displacing the power cutter holder 9 in the respective directions separately, i.e. not necessarily simultaneously.

In this embodiment, the support area 11 is comprised of a number of supporting rods 31 which extend between the upper frame part 32 and lower frame part 33. In another embodiment, the support area 11 could be a plate which e.g. completely fills out the space between the frame parts, a mesh, a support edge on the panel cutter parts or other type of support for supporting the panel(s) 3.

The portable automated panel cutter 1 comprises feet 22 which distribute the mass of the panel cutter 1 such that it is stable upon cutting operation. Furthermore, the contact surface of the feet 22 form a contact plane 25 and the panel cutter 1 is angled in relation to this contact plane 25 such that it does not take up too much space and so that panels 3 may more easily be placed in the panel cutter 1 and removed after cutting. In this embodiment the panel cutter 1 is arranged in an angle α of 75°. However, in another embodiment the angle α could angle the support area 11 more towards being vertical or more towards being horizontal.

In this embodiment the feet 22 comprises rods. However, in another embodiment, the feet 22 could comprise suction cups, wheels, shell structure, beam structure or other kind of feet for supporting the weight of the panel cutter 1 and stabilizing it.

In this embodiment the power cutter 8 is a standard off-the-shelf angle grinder provided with a cutting tool 39 (see FIG. 2) which in this embodiment is a circular cutting blade 29. Power cutters 8 of one manufacturer and different makes usually differ from angle grinders of another manufacturer and/or of other types. Thus, to ensure flexibility and manufacturer preferences, the adaptor 40 is in this embodiment connectable to different types of power cutters 8 irrespective of manufacturer or specific embodiments of the power cutter 8 (circular saw, jigsaw, angle grinder etc.). However, in another embodiment different adaptors 40 could be provided for each type of power cutter 8.

Marking the one or more panel parts 4 in the portable automatic panel cutter 1 could comprise the steps of providing instructions to a remote operator interface 2 regarding dimensional processing of a panel 3 in the portable automatic panel cutter 1, transmitting the instructions from the remote operator interface 2 to a controller 12 of the portable automatic panel cutter 1, automatically cutting the panel 3 into two or more panel parts 4 in the portable automatic panel cutter 1 in response to the instructions, and marking at least one of the two or more panel parts 4 with one or more identification marks 6 in response to the instructions.

FIG. 2 illustrates an embodiment of the power cutter 8 as seen in perspective

In a preferred embodiment, the power cutter 8 is handheld so that the operator may easily move it around. Also, since the automated portable panel cutter 1 is a dynamic system, it is important to keep the inertia as low as possible such that the resulting accelerations do not result in large forces which would require stiff supports, strong beams and also powerful displacement means. The panel cutter 1 is designed such that the operator may easily remove the power cutter 8 and use it for manual work by simply removing the power cutter 8 from the adapter 40.

More specifically, the power cutter 8 is in this embodiment an angle grinder. This type of power cutter 8 could be used for cutting gypsum plates and as this cutting process may develop a lot of dust and flakes, the power cutter 8 also comprises an extraction device 34 for venting the area at the vicinity of the cutting point 17 and the power cutter 8. Naturally, the extraction device 34 could be provided no matter which type of panel 3 is to be cut.

Also, if a panel 3 to be cut is of a type of material, which generates a lot of dust, chips and flakes, the power cutter may comprise a shield 35 for protecting the operator but also for protecting the components of the panel cutter 1. Furthermore, the shield 35 improves the efficiency of the extraction device 34 in that the cutting residues are easier guided into the extraction device 34. In this embodiment, the extraction device 34 is a ventilation system which actively sucks the dust, flakes and chips away from the power cutter 8. The extraction device 34 could then lead the residues to a container (not shown) or simply blow it out to the surroundings. But in another embodiment, the extraction device 34 could be a simple container (not shown) in which the cutting residues are conducted into without actively sucking the residues towards the container. The container could then be emptied regularly.

The drive train 36 of the power cutter 8 could comprise a plurality of shafts, gears, axles or other kind of mechanical components for transmitting a force from the electrical cutter motor 38 to a circular cutting blade 29. Thus, the drive train 8 could be designed such that the resulting movement of a cutting blade 29 mounted on the power cutter 8 undergoes a rotational movement or a reciprocating movement depending on which type of cutter tool 39 is mounted on the power cutter 8. Such a reciprocating motion could be provided by a rack mechanism, slider-crank mechanism, crankshaft, wheel-pinion mechanism or other type of mechanism for achieving a reciprocating motion. In this embodiment, the drive train comprises a rotating drive shaft 28 which is powered by the electrical cutter motor 38 and provides a rotational motion to the circular cutting blade 29 via a drive train 36 and a gearbox 37. In another embodiment, power could be provided pneumatically (e.g. via compressed air), hydraulically, an engine or other type of power source. It could also be provided directly to the cutter tool, i.e. without any gearbox. The power to the electrical cutter motor itself is provided via a power plug 21 connected to a power socket but could also be provided by a battery (not shown) which could be positioned internally within the power cutter 8. The electric cutter motor 38 and drive train 36 are in this embodiment enclosed within the power cutter 8.

In this embodiment, the cutter tool 8 is an angle grinder cutting disc which cuts the panel 3 by conducting a rotational motion. However, in another embodiment, the cutter tool 39 could be a saw blade, jigsaw blade, saw wire or any other kind of cutter for attachment to a power cutter 8 and thereby cut a material by carrying out a circulating, reciprocating or a continuous translating motion.

The independent power cutter 8 may be powered by electricity (battery, power socket), engine, compressed air or in other ways for driving the cutting motion of the power cutter 8.

FIG. 3 illustrates a cross section through a power cutter holder 9 as seen from the bottom

Some types of power cutters 8 comprise threaded holes 42 for receiving a support handle 41 such that the operator may take a firm grip of the power cutter 8. Such a threaded hole 42 may also be used for connecting the power cutter 5 to the adaptor 40. Thus, instead of inserting a support handle 41 into the threaded holes 42 a bolt 43 (see FIG. 3), pins or other type of connector may be received therein to connect the adaptor 40 to the power cutter 8.

In this embodiment, the adaptor 40 is connected to the threaded holes 42 of power cutter 8 via bolts 43. One or more bolts 43 may be used depending on the available threaded holes 42 and the size of the power cutter 8. In another embodiment the adapter 40 may be connected to the power cutter 8 via screws, pins, a bayonet mount or in other suitable way.

In this embodiment the automated marker tool 5 comprises marker displacement means 19 for displacing the automated marker tool 5 in relation to the power cutter holder 9. In this embodiment the marker displacement means 19 comprises a guide an electrical solenoid arranged for displacing the marker tool 5 back and forth but in another embodiment marker displacement means 19 could comprise means for displacing the marker tool 5 in a more complex pattern i.e. to enable that the marker tool 5 could also be displaced in the x- and/or y-direction independently from the power cutter holder 9.

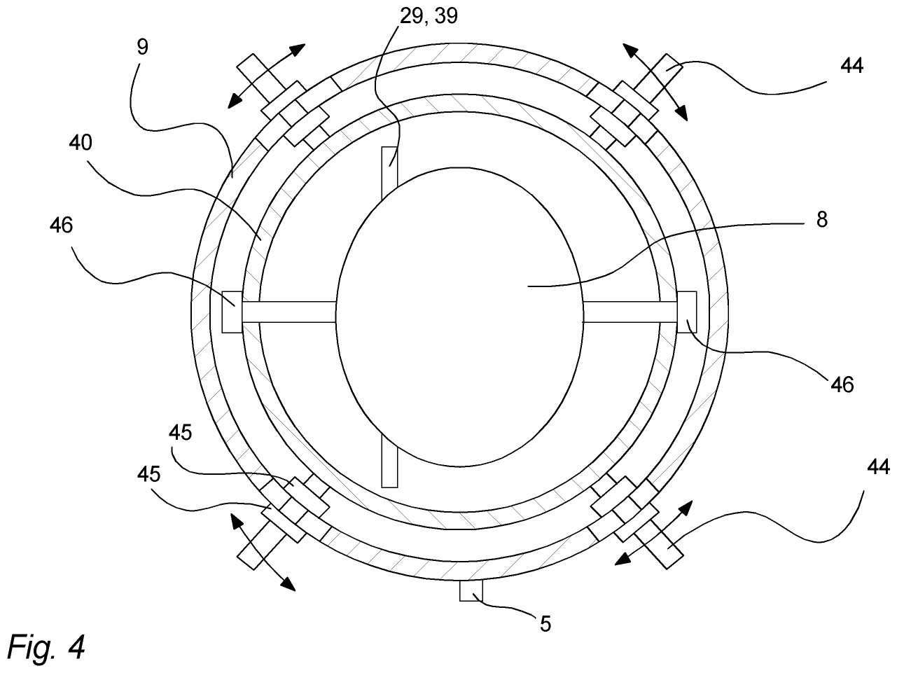

FIG. 4 illustrates a cross section through a power cutter holder 9 and adapter 40, as seen from above.

In this embodiment power cutter holder 9 holds the adaptor 10 through four adjustment means 44 of the adaptor 40 arranged to extend through elongated tracks in the power cutter holder 9. The elongated tracks allow the adaptor 40 to be rotationally aligned and the nuts 45 allows the adaptor 40 to be displaced in the x-direction and y-direction. In this embodiment the adaptor 40 cannot be adjusted in the z-direction, but in another embodiment a similar adjustment arrangement could be provided for the z-direction. It would be obvious to the skilled person that in another embodiment the adaptor 40 and/or the adjustment means 44 could be formed in numerous other ways i.e. in ways comprising adjustable arms, set screws, spacers, lock mechanisms or other for either stepless adjustment or adjustment in increments of the position of the power cutter 5 in relation to the power cutter holder 9.

In this embodiment the adaptor 40 is releasably connected to the power cutter 8 by means of two connection means 46 in the form of bolts extending through holes in the adaptor 40 and into treaded holes 42 in the power cutter 8 but in another embodiment the power cutter 8 could also or instead be releasably connected to the adaptor 40 through snap locks, interlocking geometry, clamps, grippers, belts, bands or other.

In an exemplary embodiment, a reference to a portable automated panel cutter 1 is a reference to a machinery that does not comprise a power cutter 8 i.e. the contrary to a standard CNC cutter. The power cutter 8 is a stand-alone tool and the tool holder/power cutter holder 9 of the portable automated panel cutter 1 is designed to fit to and hold the power cutter 8. When mounting the tool holder 9 in a tool holder carriage, the power cutter 8 is mounted to the machinery and the portable automated panel cutter 1 is able to cut a board to be cut. This is, in contrary to a CNC cutter done by moving the power cutter 8 including the motor driving the cutting tool/cutter tool 39 together with the cutting tool 39 when cutting the board to be cut.

In an exemplary embodiment, when a power cutter 8 is mounted in the automated panel cutter 1, the tool holder 9 (or indirectly the carriage) facilitates moving the power cutter 8 and thereby the cutting tool 39 both in the Z-direction and around the Z-direction i.e. the angle of rotation φ. Hence, the cutting tool 39 is able to be move from front of board to be cut towards the back of the board to be cut. In addition, the cutting tool 39 is able to be moved in an angle φ around the Z-axis, preferably a freedom of 180 degrees plus a margin of e.g. ±2 degrees. Such movement around the Z-axis ensures that circular cuts can be made and it distinguishes the present portable automated panel cutter 1 from known portable tools having a frame and a power tool in the form of a milling cutter. Using a milling cutter as power tool 8 reduces complexity in control of the movement of the power tool in that it only has to be moved in the X, Y and Z directions.

The marking tool can be passive or active understood in that e.g. a pen as described above is passive in that it needs to be moved by the tool holder 9 or marker holder to be able to mark part of a board. A passive marker tool can mark part of the board while the power cutter 8 is cutting the board, before or afterwards, but is best used after or before the cutting operation. Alternative is an active marker tool which can be controlled independently from the power cutter 8 such as a spray, labeling tool (sticker), stamping tool or the like as described above. Active should be understood as it needs to be activated to produce a mark. The mark could be a pattern such as a barcode or quick read code, series of symbols, numbers, letters, etc.

In a preferred embodiment of the invention, no matter type of the marker tool, it is characterized in that it is physically separated from the cutting tool 39 of the power tool i.e. the marker tool and the cutting tool 39 is typically one and the same part of the panel cutter in fact, the marking tool in most embodiments will remain located on the panel cutter when the power tool is removed and/or when the cutting tool 39 is replaced.

The portable automated panel cutter 1 is dynamic in the sense that two subsequent cuts are different from each other. This is at least true for the majority of cuttings.

The invention has been exemplified above with reference to specific examples of power cutter 8, cutter tool 39, automated marker tool 5 or other. However, it should be understood that the invention is not limited to the particular examples described above but may be designed and altered in a multitude of varieties within the scope of the invention as specified in the claims.

### LIST

1. Portable automatic panel cutter
2. Remote operator interface
3. Panel
4. Panel parts
5. Automated marker tool
6. Identification mark
7. Wireless communication means
8. Power cutter
9. Power cutter holder
10. Holder rotation axis
11. Support area
12. Controller
13. X-direction drive means
14. Y-direction drive means
15. Z-direction drive means
16. Rotation means
17. Cutting point
18. Track
19. Marker displacement means
20. Power socket
21. Power plug
22. Feet
23. Underlying ground
24. Contact surface
25. Contact plane
26. Panel cutter parts
27. Power button
28. Rotating drive shaft
29. Circular cutting blade
30. Traverse beam
31. Support rod
32. Upper frame part
33. Lower frame part
34. Extraction device
35. Shield
36. Drive train
37. Gearbox
38. Electrical cutter motor
39. Cutter tool
40. Adapter
41. Support handle
42. Threaded hole
43. Bolt
44. Adjustment means
45. Nut
46. Connection means
α. Angle between support area and contact plane

1. A portable automatic panel cutter comprising:
one or more remote operator interfaces adapted to receive instructions from an operator regarding dimensional processing of a panel in said portable automatic panel cutter, wherein said portable automatic panel cutter is adapted to automatically cutting said panel into two or more panel parts according to said instructions,
wherein said portable automatic panel cutter also comprises an automated marker tool configured for marking at least one of said two or more panel parts with one or more identification marks in response to said instructions.

2. (canceled)

3. The portable automatic panel cutter according to claim 1, wherein said automated marker tool is arranged to operate contact-free in relation to said panel parts.

4. The portable automatic panel cutter according to claim 1, wherein said automated marker tool comprises an inkjet printer, a pen, a label maker, or a laser printer.

5. (canceled)

6. (canceled)

7. The portable automatic panel cutter according to claim 1, wherein said portable automatic panel cutter comprises a power cutter releasably suspended in a power cutter holder.

8. The portable automatic panel cutter according to claim 7, wherein said portable automatic panel cutter is arranged to move said power cutter holder in a three-dimensional cartesian coordinate system and to rotate said power cutter holder around a holder rotation axis parallel to an axis of said three-dimensional cartesian coordinate system,
wherein said portable automatic panel cutter comprises X-direction drive means for driving said power cutter holder in a X-direction of said three-dimensional cartesian coordinate system, Y-direction drive means for driving said power cutter holder in a Y-direction of said three-dimensional cartesian coordinate system, Z-direction drive means for driving said power cutter holder in a Z-direction of said three-dimensional cartesian coordinate system and rotation means for rotating said power cutter holder around said holder rotation axis.

9-15. (canceled)

16. The portable automatic panel cutter according to claim 7, wherein said power cutter is a stand-alone power cutter designed to be operated by hand

17. (canceled)

18. (canceled)

19. The portable automatic panel cutter according to claim 1, wherein said automated marker tool is arranged to be automatically moved at least partly by said X-direction drive means, said Y-direction drive means, said Z-direction drive means and/or said rotation means adapted to displace a power cutter performing said cutting during said automatically cutting of said panel.

20. The portable automatic panel cutter according to claim 1, wherein said automated marker tool is provided with marker displacement means arranged independent to said X-direction drive means, said Y-direction drive means, said Z-direction drive means and/or said rotation means adapted to displace a power cutter performing said cutting during said automatically cutting of said panel.

21. The portable automatic panel cutter according to claim 1, wherein said automated marker tool comprises means for displacing said automated marker tool independently in at least one direction in relation to said X-direction drive means, said Y-direction drive means, said Z-direction drive means and/or said rotation means adapted to displace a power cutter performing said cutting during said automatically cutting of said panel.

22. The portable automatic panel cutter according to claim 1, wherein said remote operator interface is configured to receive said instructions from said operator by means of voice commands.

23-25. (canceled)

26. The portable automatic panel cutter according to claim 1, wherein said one or more identification marks comprises information that are unique for an operator or a remote operator interface.

27. The portable automatic panel cutter according to claim 1, wherein said portable automatic panel cutter comprises a power socket and wherein power to said power socket is controlled by a controller arranged to control said automatically cutting of said panel.

28. (canceled)

29. The portable automatic panel cutter according to claim 1, wherein said portable automatic panel cutter comprises a number of feet arranged to support said portable automatic panel cutter against the underlying ground during normal use of said portable automatic panel cutter, wherein a contact surface of said feet forms a contact plane, wherein said portable automatic panel cutter further comprises a support area arranged to support a panel during cutting of said panel and wherein said support area is arranged in an angle (α) between 20 and 90 degrees, preferably between 45 and 86 degrees, and most preferred between 65 and 82 degrees in relation to said contact plane.

30. (canceled)

31. (canceled)

32. The portable automatic panel cutter according to claim 7, wherein said independent power cutter comprises rotating drive shaft for rotating a circular cutting blade.

33. The portable automatic panel cutter according to claim 32, wherein said circular cutting blade is a circular saw blade.

34. (canceled)

35. (canceled)

36. A method for marking one or more panel parts in a portable automatic panel cutter, said method comprising the steps of:
providing instructions to a remote operator interface regarding dimensional processing of a panel in said portable automatic panel cutter;
transmitting said instructions from said remote operator interfaces to a controller of said portable automatic panel cutter;
automatically cutting said panel into two or more panel parts in said portable automatic panel cutter in response to said instructions and
marking at least one of said two or more panel parts with one or more identification marks in response to said instructions.

37. The method according to claim 36, wherein said method comprises the step of releasably connecting an independent power cutter to a power cutter holder of said portable automatic panel cutter before said power cutter is automatically cutting said panel.

38-43. (canceled)

44. The method according to claim 36, wherein said method is performed on a portable automatic panel cutter according to claim 1.

45. Use of a portable automatic panel cutter according to claim 1 for cutting panels on a building, repair or restauration site.

46. The portable automated panel cutter according to claim 1, wherein the portable automated panel cutter is collapsible.

47. (canceled)

48. (canceled)
